(19) United States
(12) Patent Application Publication
(10) Pub. No.: US 2001/0011265 A1
(43) Pub. Date: Aug. 2, 2001

(54) Method and apparatus for deploying data among data destinations for website development and maintenance

(76) Inventors: William G. Cuan, Sunnyvale, CA (US); Kevin Cochrane, San Francisco, CA (US); Gajanana Hedge, San Jose, CA (US); Britt H. Park, Mountain View, CA (US); Robert D. Bradshaw, Jr., San Jose, CA (US); James H. Koh, Chicago, IL (US)

Correspondence Address: David R. Stevens, Stevens & Westberg LLP, 99 North First Street, Suite 201, San Jose, CA, 95113, US

(21) Appl. No.: 09/727,975

(22) Filed: Nov. 29, 2000

Related U.S. Application Data
(63) Continuation-in-part of application No. 09/244,333, filed on Feb. 3, 1999.
(60) Provisional application No. 60/168,156, filed on Nov. 29, 1999.

(51) Int. Cl. G06F 7/00

(52) U.S. Cl. 707/1

(57) ABSTRACT

A method and apparatus are provided for dynamically organizing and tracking website content during its deployment. Organizing and tracking may be done internally to a website development system during development and externally to outside destinations such as production servers that provide access to websites via the Internet or intranet. The method of internal deployment includes the process of deploying data among workstations, storage areas, such as a backing store, staging areas, editing areas and other internal areas during the development of website content. According to the invention, a tracking system is able to track such changes as the content is being created, including information regarding their source and history. The method of external deployment includes different schemes for deploying the finished website content to one or more destinations, such as production servers, including a method for tracking the external deployments as to what content is sent, to where and by whom. The invention also includes a method and apparatus for creating templates for use in deploying data, both internally and externally. The method of using templates provides a highly configurable way to capture, edit and store data imported from end-users who are developing websites. The method also provides for the integration of captured data with other applications. The invention accomplishes this by efficiently keeping the data separate from the data template presentation. The method allows the transfer of the data separate from the presentation so that the data can be modified and so that different templates can be utilized for presenting the data.

### RELATED APPLICATIONS

This application claims priority of U.S. Provisional Application Ser. No. 60/168,156, filed Nov. 29, 1999. This application is a Continuation in Part of U.S. patent application Ser. No. 09/244,333 Filed Feb. 3, 1999, pending.

### BACKGROUND

The invention relates generally to methods and apparatuses for developing and maintaining network websites and, more particularly, to a method and apparatus for managing the deployment of data both internally and externally among one or more destinations while developing and maintaining network websites.

Applications specifically tailored to developing Internet websites are well known in the website development industry. Many of these applications offer simplified methods for designing and maintaining a website such as receiving, storing, arranging and delivering information within a website. In more advanced systems, information must be stored in multiple locations and in different files so that other advanced functions of the application program can operate and have access to certain information.

It is often a challenge to develop large websites due to the need to coordinate the efforts of many contributors. As a result, modern website development tools have been developed that enable multiple workstations to concurrently create website content. Furthermore, many websites need to be frequently modified, and contributors usually modify them in an ad hoc process. Problems occur when users from separate workstations try to update the same information on a website, confusing the process. Propounding the problem, many businesses require that their Internet sites be updated by the day, hour or minute, and by numerous contributors. And, as the number of contributors increases, so does the volume, and complexity of content, as well as its use. As a result, managing the website for efficiency and quality control has become difficult.

As a result, system applications have been developed for managing website development. Some of these include software configuration management systems, document management systems and database publishing systems. In one such application, websites may be developed within work areas where individual website developers construct or maintain separate portions of content that define a website. This helps to spread out the tasks of website development to multiple people. The final contributions from each developer may then be incorporated into the final website.

There are several disadvantages associated with such known website development systems. For example, where maintaining a website may require the efforts of large numbers of people, it may be desirable to have website contributors work in parallel. Software configuration management systems do not allow contributors to simultaneously make changes to the same area of a website. And, conventional systems typically do not allow individual contributors to separately test their own work without publishing to the website. The result is that individual contributors cannot foresee the effects of their contributions when combined with other contributions. As a result, conflicting changes may be posted to a website, corrupting its content and undermining the website's integrity.

Conventional systems sometimes rely on a central website control person known as a “webmaster” to integrate all changes posted to a website. This webmaster is solely responsible for the quality control of the website and for integrating all of the content. With the existence of multiple content contributors, the webmaster often becomes a bottleneck in maintaining and developing websites. Integrating the work of multiple contributors is a time consuming and labor intensive task, and includes debugging the content and resolving conflicts among contributors. To further complicate things, webmasters have no real-time control over the contribution process. This makes it difficult if not impossible for the webmaster to properly organize and maintain a website. The webmaster is left to sort through errors, to resolve conflicts and to schedule website changes after the content is delivered.

Accordingly, it would be useful to dynamically organize and track website content including information and graphic displays as they are being modified by individual contributors. The content could then be deployed to a website in an organized manner. As will be seen, the invention accomplishes this in a useful and elegant manner.

### BRIEF DESCRIPTION OF THE DRAWINGS

FIG. 1 is a diagrammatic view of a website development system for hosting a deployment method according to the invention;

FIG. 2 is a diagrammatic view of a data deployment system according to the invention;

FIG. 3 is a diagrammatic view of a data deployment system according to the invention;

FIG. 4 is a diagrammatic view of a data deployment system according to the invention;

FIG. 5 is a diagrammatic view of a data deployment system according to the invention;

FIG. 6 is a diagrammatic view of a tracker table according to the invention;

FIG. 7 is a diagrammatic view of a data deployment system according to the invention;

FIG. 8 is a diagrammatic view of a data deployment system according to the invention;

FIG. 9 is a diagrammatic view of a data deployment system according to the invention;

FIG. 10 is a diagrammatic view of a data deployment system according to the invention;

table 1 is a chart illustrating a deployment method according to the invention;

table 2 is a chart illustrating a deployment method according to the invention; and

table 3 is a chart illustrating a deployment method according to the invention.

### SUMMARY OF THE INVENTION

A method and apparatus are provided for dynamically organizing and tracking website content during its deployment. Organizing and tracking may be done internally to a website development system during development and externally to outside destinations such as production servers that provide access to websites via the Internet or intranet. The content may include data, graphic displays and other content including such content undergoing modifications by individual contributors and deployment within a system. A system incorporating the invention would be able to create and stage proposed changes for scrutiny before the final product is deployed to a website. The deployment of the data, both internally to the development system as well as externally to a destination, such as a production server, is accomplished in an organized manner. The method of internal deployment includes the process of deploying data among workstations, storage areas, such as a backing store, staging areas, editing areas and other internal areas during the development of website content. According to the invention, a tracking system is able to track such changes as the content is being created, including information regarding their source and history. The method of external deployment includes different schemes for deploying the finished website content to one or more destinations, such as production servers. A similar tracking system may also be included for tracking the external deployments to keep track of what content is sent, to where and by whom.

The invention also includes a method and apparatus for creating templates for use in deploying data, both internally and externally. The method of using templates provides a highly configurable way to capture, edit and store data imported from end-users who are developing websites. The method also provides for the integration of captured data with other applications. The invention accomplishes this by efficiently keeping the data separate from the data template presentation. The method allows the transfer of the data separate from the presentation so that the data can be modified and so that different templates can be utilized for presenting the data.

The templating mechanism for capturing data content from end-users may separate from the mechanism for defining the appearance of the contents when it is displayed. This architecture allows for the unlimited re-use of data after the data is captured and stored. It further allows a user to define different appearances and behaviors for the same data content based on how, when, where, or to whom the data is displayed. Once the data is captured, it can be merged with presentation templates and displayed, or optionally deployed to a database for storage. The isolation of the data apart from the manner in which it is presented allows for easy manipulation of the data and efficient storage.

### DETAILED DESCRIPTION

The Invention provides a method and apparatus for deploying website content. The method may store and track proposed content changes during or before deployment to a website. To accomplish this, an organized tracking system is provided to keep track of changes made by other people operating within separate workstations. A staging area may be included to post proposed changes to a website and to track their source and history. The method may include the ability to track the transfer of data among several data destinations used in developing and maintaining websites. In operation, while each user makes contributions to the development of a website by performing assigned tasks, the user's content may be separately stored and tracked by the system internally so that the source and history of content changes can be kept track of during development. Also, tracking can include recording the source and history of content that is deployed externally so that external deployment of the content can be optimized. Such changes may include proposed changes to an existing site or new content. A template mechanism is provided to further organize both the capturing of data during development and the presentation of content on a website. And, although the invention is described in the context of a system and method for website maintenance and development, it is not limited to any narrow interpretation of such implementation, but may be applicable to other applications where the efficient organization, tracking and deployment of data is desired.

There are many advantages of a website management system or any similar system employing the invention. Such a system would be able to fully control the creation, maintenance and release of versions of website content. It further allows the control of who can authorize a release, based on predetermined priorities. Such a system is able to govern that which any one person or entity can release based on predetermined authorizations. It may also control where content can be released, whether it is released at one or more websites, and the manner in which a release can occur.

Such a system would also have the ability to automatically control content distribution. Content may be distributed according to certain events. Releases that occur in response to the occurrence of such may be preauthorized so that the release occurs automatically. Using a system that employs the features and methods of the invention may allow the application of complex distributions of content among one or more websites. Such a system would be flexible enough to perform a virtually infinite number of possible combinations and permutations of content deployment and tracking tasks.

Deployment of content according to the invention may also benefit a system by improving the integrity of information transmissions. Given the control of the deployments, the transmissions of information are actually transactional in nature, where certain safeguards are established to ensure proper deployment. Control of the deployments may also allow for the rollback of an external deployment before it occurs. With robust control features provided, a deployment can be held back for analysis before the deployment occurs.

Employing the invention, a website management system may also be highly scalable. Since complex hierarchies of control may exist in such a system, the invention could allow a website management application to be flexible enough to accommodate a sizeable team of content contributors in a system. Such a system could then accommodate virtually unlimited amounts of content contributed from multiple sources and deploy the content to one or more destinations in an efficient and organized manner.

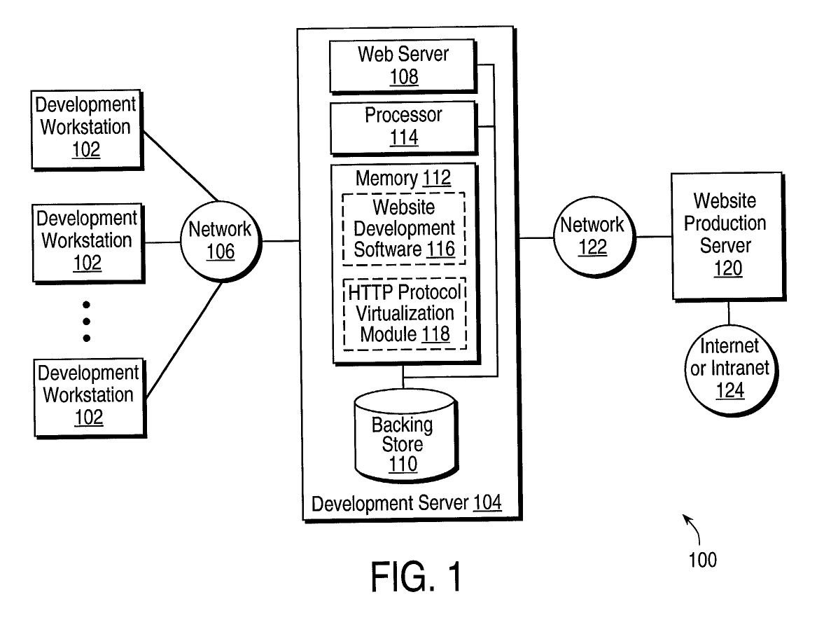

Referring to FIG. 1, a computer network system 100 for website development is illustrated. In development workstations 102, website developers may add, remove, edit and examine files for a website. Development workstations may include conventional personal computers, UNIX workstations, or other workstations that can be configured to develop content. The development workstations 102 may be connected to a development server 104 via a computer network 106, such as the Internet or LAN.

The development server 104 may include a web server 108 for serving up content to web browsers, and a backing storage 110 for storing versions of website content. The server 108 processes HTTP requests from the development stations 102 for website content (e.g., files). The website files may be physically stored in the backing store 110 which may be conventional, such as the WINDOWS NT files system commercially available from Microsoft Corporation.

The development server 104 may also include a conventional memory 112 (e.g., RAM) and a conventional processor 114, which implements the website development methods of the present invention by executing software 116 stored in the memory 112. An HTTP protocol virtualization module 118 may be executed by the processor 114, allowing web server 108 to operate as if it were multiple servers. The module may also be stored in the memory 112. The development server 104 may be coupled to a website production web server 120 via a network 122. Network 122 may be the same network as network 106 or a different network. The web server 120 may also be coupled to the Internet or an intranet 124. When a website is ready to be posted on the World Wide Web or on an intranet, the development server 104 sends the website content to the production web server 120 which then provides Internet or intranet access to the website.

A website is generally comprised of the contents of an arbitrary file system. The website development system 100 of the present invention may include hierarchical file systems. Each such file system of the present invention provides an environment for managing and manipulating individual files. When executed, the website development software 116 enables the management and manipulation of files. The backing storage 110 is where the files and corresponding metadata, e.g., owner identification, group identification, access control, file name, modification times, creation times, extended attributes (EAs) etc., may be physically stored.

A hierarchical file system of the present invention is referred to an “area.” There may be different types of areas including work areas, staging areas and edition areas. A work area is typically a modifiable file system that is used by persons who create and maintain web content in work files for eventual use in a website. A staging area is usually an area where content from these work files is assembled before it is published. A central control person, such as a webmaster, may edit content submitted from work areas within a staging area or an edition area. Since the work areas are generally areas for creating and maintaining content exclusively, the staging and edition areas may be restricted to only assembling and displaying content. By design then, they may be configured as read-only file systems. Any modifications to content may then possibly need to be sent from an editor back to a workstation to perform any changes that may be needed. This helps to maintain the integrity of the content and to simplify the process. However, a business may want the system 100 to be more flexible, allowing other people such as editors to modify the content before it is published. The staging and edition areas may then be configured as modifiable file systems.

A work area may initially include a virtual copy of an entire website, unless there is no existing website, in which case the work area may be empty. In other words, a work area may initially have the same contents as the file system designated as the website. A work area provides a developer's personal view of a website in which the developer may contribute to the website. For example, in a work area, developers can freely add, delete and modify website content and see how their changes fit into the context of the entire website. Changes made by developers in work areas preferably do not affect the website or the work of other contributors in other work areas. This is because each work area may be a separate file system. Typically, a work area is located at workstation 102.

Developers may integrate their work in a staging area by submitting the contents of their work areas into a staging area. This action is referred to as an internal deployment, or a simple data deploy, where data is transferred to a backing store, which contains file versions of web content. The staging area is a file system available to multiple developers that provides a shared view of the website. Thus, a staging area may hold the collective work of several developers' work areas and may allow the developers to share and integrate their changes. In a staging area, the developers can see how their changes fit together. The staging area is typically located at the development server 104.

Copying is said to be “virtual” where areas share directory trees, but are configured such that the directory trees do not need to be physically copied. The collective work in a staging area changes as different contributors submit new content from work areas. Work areas are most effective when the content and other information in the staging area is virtually copied back to one or more private work areas. This helps to keep the individual work areas up-to-date with respect to the staging area while contributors are performing website related tasks such as creating and maintaining content.

When the collective work in a staging area is deemed final, its contents can be published to create an edition of the website. This may be accomplished by virtually copying contents of a staging area onto an edition area. Because an edition is typically a read-only file system, it is a frozen snapshot of the content of the entire website. Each edition taken at sequential points in the development of a web site may be archived and accessible to all developers so that developers may instantly recall files, entire directories, or reconstruct entire past versions of the website. For example, the contents of an edition may be virtually copied into a work area to be used as a basis for further development of the website. An edition area is typically located in the production server 120. The invention provides for the deployment of such data so that virtual copies of information will be available for workstations.

So that the website development and maintenance work progresses in a predictable and orderly fashion, tasks are assigned and performed in accordance with a workflow, also known in the industry as a “job”. The workflow configuration, or job, is a calculated arrangement of tasks to be performed. The arrangement may include tasks performed in serial order, in parallel with each other or in combinations of serial and parallel operation. A workflow model is a general workflow configuration that can be used repeatedly. Each workflow model describes a process that can include user tasks as well as a wide variety of automated tasks. Workflow models are typically designed by business managers and configured by a system administrator. The present invention provides the ability to enable a workflow configuration to be organized and managed according to the criteria established within the system.

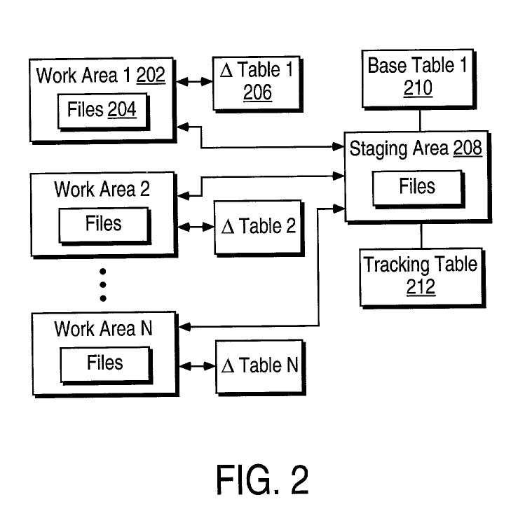

Referring to FIG. 2, a general block diagram of a website development system is illustrated. A first work area 202 includes memory for temporarily storing files 204. The files 204 define the portion of the website to which the user of the work area 202 is contributing as well as the changes the user is making. In communication with the work area 202 is a table 206, referred to herein as a delta table. The delta table 206 maintains indicia of changes made by the user in work area 202. Work area 202 is in communication with a staging area 208. As also illustrated, number of additional work areas (work areas 2-N), each with a delta table (delta tables 2-N), may be in communication with the staging area 208. These allow one or more users to operate in separate work areas to develop content.

In the staging area 208, individual contributions from the various work areas are organized and tracked. Base table 210 is a storage area of the staging area 208 that maintains indicia of a base website configuration, such as an original version before it is modified in one or more workstations. This gives each work area a baseline from which to add, delete or otherwise modify content. The information maintained in the delta tables is with respect to the original website configuration information maintained in the base table 210. Thus, the contents of the base table 210, taken in combination with the contents of the delta table 206, specifies the website as modified in the first work area 202.

In operation, a user in work area 202 may download a file or files containing some or all of the current data appearing on a website. This data file may include content, metadata, extended attributes, etc. An extended attribute is information attached to a file that is representative of information contained in the file. The downloaded file or files may be considered a type of “snapshot” of the website as it exists at a particular time. The user of work area 202 may then perform one or more tasks which result in changes to the website snapshot. The changes with respect to the snapshot are recorded in delta table 206. Once the user's task is completed, the user can submit the proposed changes to the staging area 208 for eventual recordation in base table 210. A decision is then made by a decision-making authority (e.g., a designated “webmaster”) as to whether to incorporate the changes so as to update the final website in response to the changes.

The user of the work area 202 may also update its snapshot of the website by requesting an update from the staging area 208. Depending on the circumstances, this update may affect the user's snapshot of the website in a number of different ways. In one embodiment, changes made to the website in other work areas are incorporated in the user's snapshot, thus, updating the user's snapshot. In another embodiment, the snapshot is maintained in the work area 202 unchanged from that of the staging area 208, such that the same snapshot of the database may be used in each work area unaffected by changes made in the other work areas. Tracking table 212 tracks the different changes proposed for the website as it is modified in response to changes proposed by each work area and accepted by the authority in the staging area. The tracking table 212 is configured to track the various tables created, such as base tables, and also tracks the interrelationship among the various tables. The tracking table may keep track of the characteristics of the different tables such as the times and dates in which they are created, the interrelationships of the tables such as which base tables correspond with different delta tables, and other characteristics.

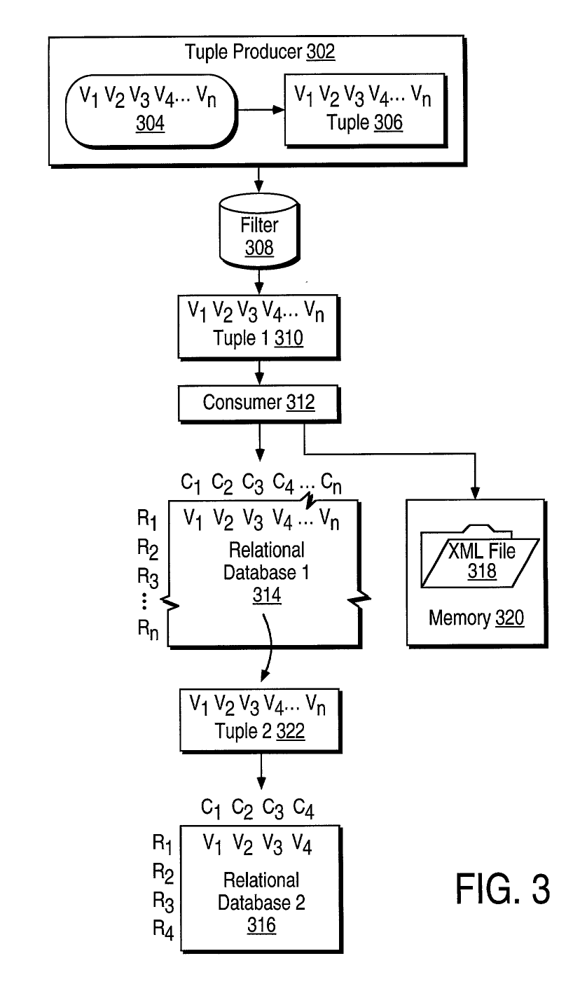

Referring to FIG. 3, an operational flow diagram of the system 100 (FIG. 1) is illustrated. The data deployment method illustrated is computer-implemented for deploying data within a website development environment. An example of such an environment is a development system made up of development workstations 102 and development server 104 connected by network 106 in FIG. 1. These deployments are internal to a development system, as opposed to external deployments, which would be deployments to destinations outside a development system. An example of an external deployment would be from a development system (such as 102, 104, 106 above) to production server 120 via network 122. The development system is configured to transfer data within the system in a useful manner in order to organize and track website development activities by concurrent users. Information may be transferred and tracked within the development system in the form of tuples.

Generally, tuples are ordered sets of particular elements. More specifically to the invention, tuples are standard sets of data that define the proposed changes to a website by a work area. For example, each tuple may include the following information fields:

1. Path: An area-relative path name of the file associated with a key-value pair (see below.

2. Key: The name of the extended attribute key (also known as the extended attribute class). For example, “News-Section” is the key of the extended attribute “News-Section: Sports.”

3. Value: A data value for the item stored in the tuples' Key field. In the above example, “Sports” is the value. Thus, a key-value pair includes a key and an associated value.

4. State: The status of the tuple. For example, a proposed change to a website represented by a tuple can be characterized as “new,” “modified,” “deleted” or “not present.” If information is unchanged for the website, the term “original” may characterize the state of such unchanged information.

The use of tuples in deploying data both internally and externally provides a website maintenance application to track data deployments throughout the system 100 (FIG. 1). Tuples may be produced in the system where data is located, the location where it is to be deployed. For example, information may be deployed from the work area 202 to its associated delta table 206. In this situation, a tuple producer 302, which may in fact be the work area 202 itself, may package the data as a tuple and send it to a tuple destination 312, such as a database or other storage area, staging area, base table, delta table, etc. The tuple can then be transferred to a relational database 314, such as the base table 210 of the staging area 208, for storage. The mapping of tuples in such a relational database is triggered by the action of storing the tuples.

One such tuple format is illustrated below. In this example, Tuple 1 is for a “News-Section: Sports” extended attribute from the file “docroot/news/front.html”. Tuple 2 is for the “Locale: SF” extended attribute from the same file. Once configured into the tuple format, the tuples can be deployed into the specific destination, such as a production server, using section and formatting rules of deployment discussed below.

| Tuple Sample | | |
|---|---|---|
| Attributes | Tuple 1 | Tuple 2 |
| Path | docroot/news/front.html | docroot/news/front.html |
| Key | News-Section | Locale |
| Value | Sports | SF |
| State | Original | Original |

As mentioned, the relational database 314 may be the base table 210 of the staging area 208, which stores all information related to the base website information. As another example, relational database 314 may store a work area's delta table, such as the delta table 206, which stores the changes made by the work area 202. The tuple may also be sent to memory 320 and stored in an XML file 318. This could, for example, represent storage of the snapshot of the website in file storage 204 of the work area 202. Tuples may also be transferred among relational databases 314, 316. This could represent the transfer of data from delta table 206 to base table 210, such as when a submission of changes is made from a work area to a staging area. Using this system of data deployment, information can easily be transferred between work areas and staging areas so that website contributions can be organized and tracked.

A tuple may also be passed through a filter such as in filter 308. The filter may be a software module placed at any point of the system, which reads, modifies and sends tuples. Thus, tuples can be modified anywhere in the system. A filter may alter certain attributes of tuples and may have an expression for transformation of the tuples. For example, one may assume a particular Key is a particular persons' age in years at a particular point in time. A filter may convert all such Keys to a range of ages, thus associating each person with an age group rather than a specific age.

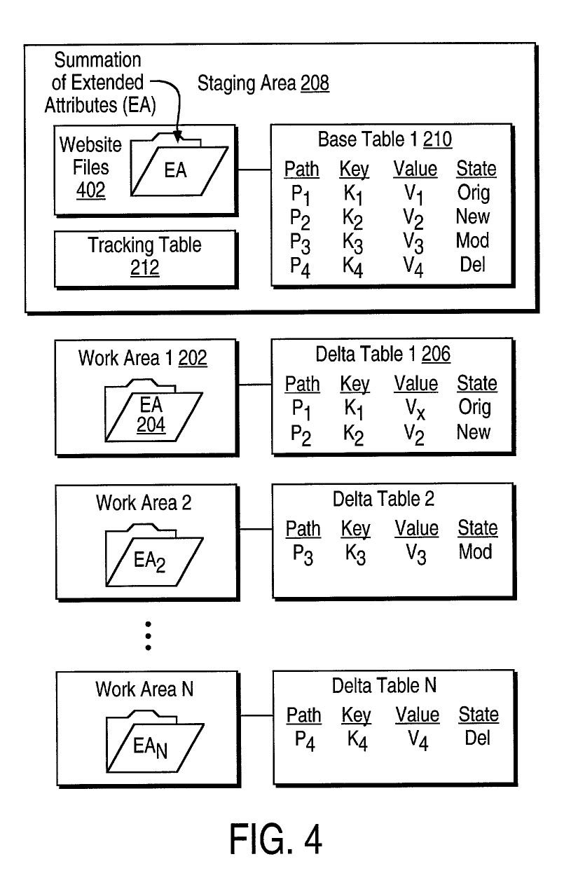

Referring to FIG. 4, a block diagram of the website development system of FIG. 2 is illustrated in more detail. Staging area 208 includes website files 402 which may include a summation of the extended attributes contributed by the different work areas. The extended attributes may be extracted from the corresponding files, converted to tuples by a tuple producer and stored in the staging area 208. The tuples stored in the staging area 208 may be organized in base table 210 and versions of website tracked in tracking table 212. The base table 210 keeps track of the path, key, value and state of information, e.g., extended attributes converted to tuples, related to a website. As can be seen in base table 210 of FIG. 4, the state can include original designation (i.e., “Orig”), new designation (i.e., “New”), modified designation (i.e., “Mod”) and deleted designation (i.e., “Del”). The base table 210 can also include fields where information is not present.

Work area 202 may include extended attribute files 204 that contain information related to the contributions of a user in work area 202 to a website. The extended attributes may be converted to tuples. Delta table 206 organizes the website information, such as the tuples, related to work area 202 with respect to the base website. For example, in the path P₁, information is contained that is original, or in other words, unchanged from the original website snapshot.

In operation, a work area 202 can receive a snapshot of a database from base table 210, which includes all relevant information of a website. While working on the website, work area 202 will track changes made by a user in delta table 206. Information received from the base table 210 will then be modified by changing the path, key, value or possibly the state of the information. Once a work area has completed a task, it can submit a tuple to the staging area for recordation of the changes. The changes are recorded on the base table 210. The change is also recorded in tracking table 212, which dynamically tracks the changes being made by the workstation.

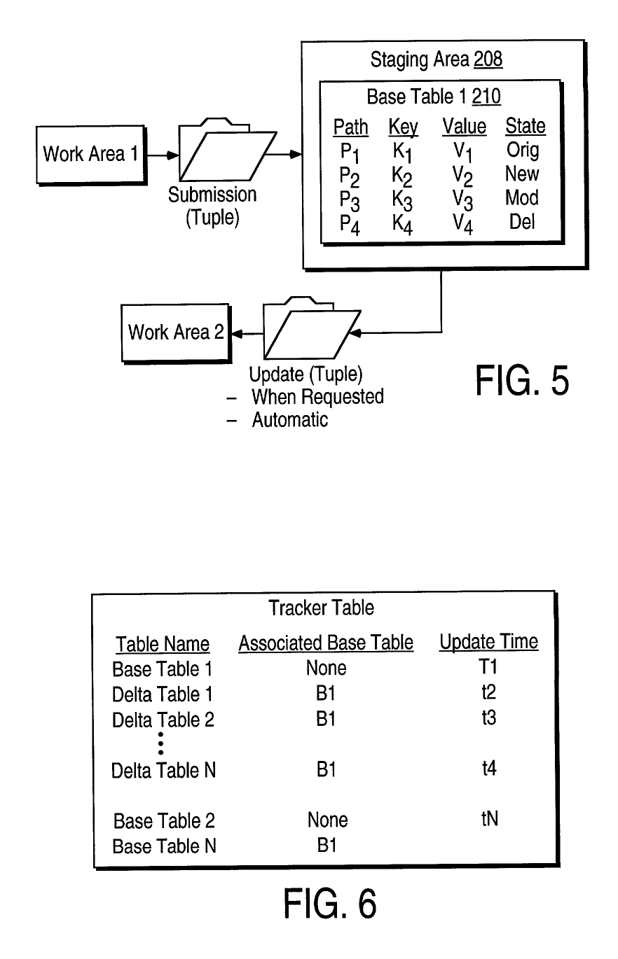

Referring to FIG. 5, which is a more detailed diagram of the staging area 208, a work area can receive an update, sent in the form of tuples, in order to update the snapshot of the website in which a user is working. A development system can be configured to update the work area, for example, when requested by a user. In a preferred embodiment, updates to a work area are limited to information that has been submitted and approved for the final website. This can be done either automatically or in response to a request from a work area. This feature allows a system to maintain consistency so that all work areas are modifying a website using the same snapshot.

Referring to FIG. 6, a tracker table for use in tracking internal deployments is illustrated. The tracker table is a registry of tables that exist in the development system. The tracker table, for example, may keep track of the table names, such as the base or delta tables, the associated base table and the time in which an update was made. For example, as illustrated FIG. 4, delta table 206 is associated with base table 210 and, within the tracker table, would be represented as such. Using the tracker table, all changes made to web content may be maintained in memory for use by the system.

Similarly, external deployments that occur between a development system and an external destination such as a production server may be tracked by logging these transactions. A log of deployments may be maintained at each end of the transaction so that both entities may maintain the deployment history. A development system may keep a Server Log that tracks log entries that are relevant to the development of content that is deployed. Similarly, a destination such as a production server may keep a Client Log, which records log entries that may be relevant to a production server. These logs may or may not be identical, depending on the individual system configurations. Such a history may include source information of the content, destination information, reasons for deployment, error alerts, and other information that may be relevant or otherwise helpful to external deployments. The logs may be in various levels of detail. The reasons a deployment is made may be deployed along with a content deployment and may include the following reasons illustrated in the table below.

| Reason for Deployment | Description |
|---|---|
| Missing_in_dest | For directory difference comparison, the |
| | element or file is not on the target (or client) |
| | server. |
| Missing_in_src | For directory difference comparison, the |
| | element or file is not in the development |
| | server. |
| Src_is_newer | For directory difference comparison, the |
| | element is newer on the development server. |
| Src_is_older | Applies when revert is specified. For directory |
| | difference comparison, the element is older on |
| | the development server. |
| Type_different | Elements with the same name are of different |
| | types of elements depending where they reside. |
| | For example, the element found on one server |
| | or area is a file, while the element with the |
| | same path on the other server or area is a |
| | directory. |
| User_different | User is different. |
| Groug_different | Group is different. |
| Mode_different | Permissions are different. |
| Size_different | The file size is different. |
| No_prev_data | New entry in the log, no related data exists. |
| File_list | The file was specified in a file list. |

Using these reasons, along with other criteria, a log may be generated on either side of a deployment in order to track such deployments. The table below illustrates and example of a log file that may be used as a Client Log or a Server Log, i.e., either side may also keep copies of the log that is kept on the other side of the deployment.

| Server Log | Client Log |
|---|---|
| Server: Waiting for connection. | Client: Initiated connection |
| Server: Received Connect request! (1) | Protocol Version (2.0) OK |
| Protocol Version (2.0) OK | Transaction mode (off) |
| Transaction mode (off) | Mode (normal) |
| Mode (normal) | Protocol (normal) |
| Protocol (normal) | Host name (bogus) |
| Host (bogus) | Name (forward_deploy) |
| Name (forward_deploy) | Client: Local directories to deploy (1) |
| Server: Receiving item (./onedir) | Client: Options: delete file 3.a |
| Server: Receiving item (./onedir) | Client: DEPLOYING (/u/iw/cuan/deploytest/ |
| | deploysrc/dir3) to tmp branch1 |
| Server: Receiving item (./onedir/onedir.txt) | Client sending: [./one.txt] Reason |
| Server: Receiving item (./onedir/onedir.txt) | [src_is_newer] |
| Directories deployed (2) Files deployed (4) | Client sending: [./one.txt] Reason |
| | [src_is_different] |
| Directories failed (0) Files failed (0) | |
| | Client sending: [./one.txt] Reason |
| (Thurs. Apr 29 11:29:42 2000) | [src_is_different] |
| Deployment completed. | Client sending: [./one.txt] Reason |
| | [src_is_newer] |
| ... | |
| | Remote status: server OK |
| | (Thurs. Apr 29 11:29:42 2000) |
| | Deployment completed. |

From a user's point of view in a work area, the system keeps track of changes internally, transparent from the user. Externally, however, the user in a work area may view the entire environment, which is a snapshot of the proposed website page or pages of the website that the user is working in and is allowed to make changes in. This snapshot can be replicated to other branches in a system so that other users may work on a similar snapshot of the website in their work area. The delta and base tables may also be used interchangeably within a branch so that information of an entire website or number of websites can be tracked efficiently.

According to the invention, once files are created in the development area, they may be deployed to an external destination, such as a production server. The deployment is an open type of deployment, which means that it allows flexibility in sending content to the external destination, and may include deployment to multiple destinations. The mechanism for external deployment may be different than that used internal to the development server. The manner in which files are deployed is dependent on the application. For example, one way to deploy files and directories is by directory comparison. This option could compare the directory being deployed from the source, such as an editing area or some other area prior to publishing, to a directory at the destination, such as a production server that hosts a website. It may by default deploy only the files from the source of deployment that are newer than their corresponding files at the destination, or that vary in size or other in other attributes than those at the destination. This configuration may be useful as a default deploy directory for websites that need to be updated on a regular basis. It makes sense that updating a website would be a more common occurrence, as opposed to possibly reverting back to old content as discussed below, which may be only occasionally useful.

Referring to Table 1, an embodiment of such a configuration is illustrated. In this configuration, only files that are newer or that are different in size or other attributes are deployed from the deployment webserver, e.g., sever 104 (FIG. 1) to the production server, e.g., server 120 (FIG. 1). Those that have not changed or that are simply older are not deployed. For example, File 1 in the development server is older than the corresponding file by just under 3 days, so it is not deployed. Similarly, File 2 has the same date and size as its counterpart, so it also is not deployed. File 3, however, is newer in the development server than its corresponding file in the production webserver, so it is deployed. Similarly, File 4 is of a different size than its counterpart file, so it is deployed as well. File 5 of the development webserver simply does not exist in the production server, so it is deployed with the others. In contrast, File 6 does not exist in the development server, so it may be ignored. It is possible, however, to delete the file on the production server with a command sent along with the deployment. Using these file deployment options, the production server may be updated according to the comparison protocol established within the software application that configures the deployment of the files.

Another configuration for specifying which files to deploy is a revert option. The revert option allows the production server to revert back to previous content displayed on a webserver. This option may be useful, for example, if an update to a website was meant as a limited offer or that was possibly inaccurate. For example, if an airline wanted to offer a low fare for a certain flight, but only wanted to run it for a week, it could first deploy updated files using a default deployment as discussed above to produce a special fare rate on the website. After the limited period for the special fare, it may then want to revert back to the original offer. The revert option would do just that. The content on the web would revert back to the original fare offer, ending the special fare offer. This may also be useful for correcting a mistake. For example, if the new low fare was mistakenly too low, the revert function may allow the airline to conveniently revert back to the original fare, saving themselves from financial loss.

Referring to Table 2, a scenario illustrating one embodiment of the revert option is illustrated. In this embodiment, when the revert option is invoked, only older files or files whose size has been changed are deployed. File 1 in the development server, which is older than its corresponding file in the production webserver, is deployed. This is in contrast to the default function discussed above, which did not deploy the File 1 because it was older. Similarly to both methods though, File 2 is not deployed to replace its counterpart, since it is unchanged in both age and size from its counterpart found in the production server. File 3, again unlike the default method, is not deployed because the file from File 3 in the production server is older. Since this method is reverting to the former content, the older file is kept in tact in the production server. File 4 is deployed to the production server to replace its counterpart in the second method, as it was in the first method, but for different reasons. In the first method, the purpose was to send any file that has changed in size. One reason for this may be that, if the date and time are the same, but the content has changed in size, then the content may have been deployed initially in error. From one perspective, this gives deference to the development server for accuracy and integrity of the content. FIG. 5 shows deployment to the production server in this second method, but, again, for different reasons than the first method. In the first method, one of the goals was to update old files on the production server with files that were created on the development server. The opposite goal is desired in the second method. Since File 5 does not exist in the production server, it is presumed that the file was deleted in the later version. Therefore, reverting back to the older version may require that the file be deployed. The system could, however, be configured to simply not transfer the file in this case. Similarly to the default method, when a file such as File 6 exists in the production server, and does not have a counterpart in the development server, the file may be left alone or may be deleted by a separate command. If the concern is that the production webserver content will not fully revert back to an older version of the content if the file is new, or if the file was actually deleted in the production server, then the system may be configured to delete the file upon deployment of the other files sent for the reversion. If this is not a concern, then the file may be left to remain.

In another configuration, files may be deployed if there is any change in the size of the file or the date the file was created. This may be helpful if a hybrid of the default and revert configuration is desirable. For example, an airline website may desire to offer special lower fares in one area of the website, yet revert another fare back to an older offer in another area of the website. This third configuration would then be useful. Referring to Table 3, a scenario illustrating one embodiment of such a configuration is illustrated. As can be seen, all files may be deployed to replace their counterparts, except when the date is the same. Similarly, when a file exists in the production server but not in the development server, the system may be selectively configured to either leave or delete the file from the production server.

The manner in which the files are deployed depends in part on how certain files are excluded, deleted, ignored or otherwise handled in achieving the goals set out by the system administrator in deploying files. According to the invention, when a file or directory is excluded, it is not deployed. Files may be excluded on the development server, e.g., 104 (FIG. 1), the production server, e.g., 120 (FIG. 1), or both servers.

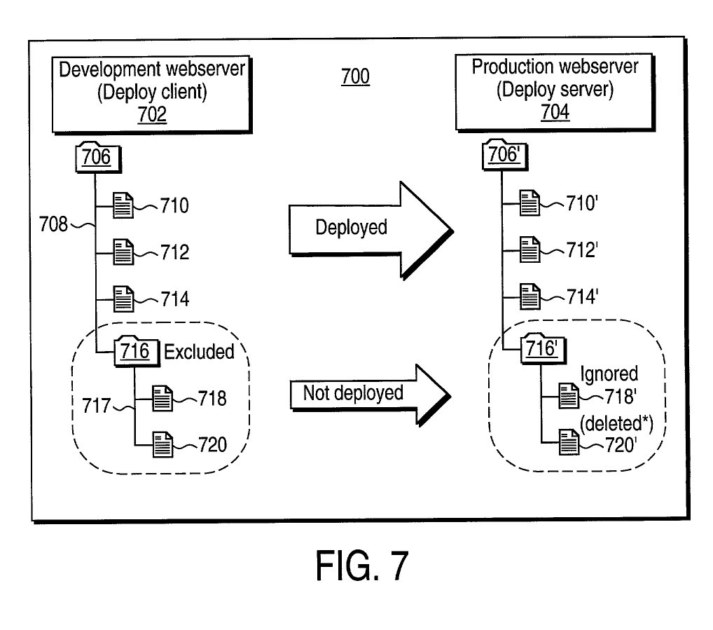

In one embodiment of the invention, during deployment, when a file is excluded on the development server, it is treated as if it does not exist. If this same file is excluded only on the source side, and a “delete file” command is included, then the corresponding file in the production server is deleted. If a delete file command is not specified upon deployment, then the corresponding file or directory is ignored on the destination side, in one example, the production server. Referring to FIG. 7, such a system 700 is illustrated. The system 700 includes a development webserver 702, otherwise known as a deploy client, that is configured to deploy files and directories production webserver 704, also known as a deploy server. The development server 702 may be configured to create and maintain content, such as that to be deployed to a production server that hosts a website. The production server 704 is configured to receive such deployments from the development server 702. The production server 704 may include one or more files and associated directories. Directory 706, for example, includes a branch 708 that associates files 710, 712, 714 with the directory. Similarly, sub-directory 716, which is associated with directory 706 via branch 708 includes branch 717 that associates files 718, 720 with the sub-directory. The production webserver 704 includes corresponding directory 706′ that includes files 710′, 712′, 714′ associated with that directory. Similarly, corresponding subdirectory 716′ includes corresponding files 718′, 720′. In this scenario, subdirectory 716 along with files 718, 720 are excluded from deployment, and file 720 is further targeted for deletion. Upon deployment, both files 718, 720 are set for exclusion. Corresponding file 718′ is ignored. Corresponding file 720′ is deleted according to a delete file command transferred with the development server 702. It may also be advantageous to exclude only certain files or directories from the development server 702. For example, a main directory along with its associated files could be excluded from a deployment, with its subdirectories not excluded. Many different scenarios are possible when excluding different files and directories at the development server 702.

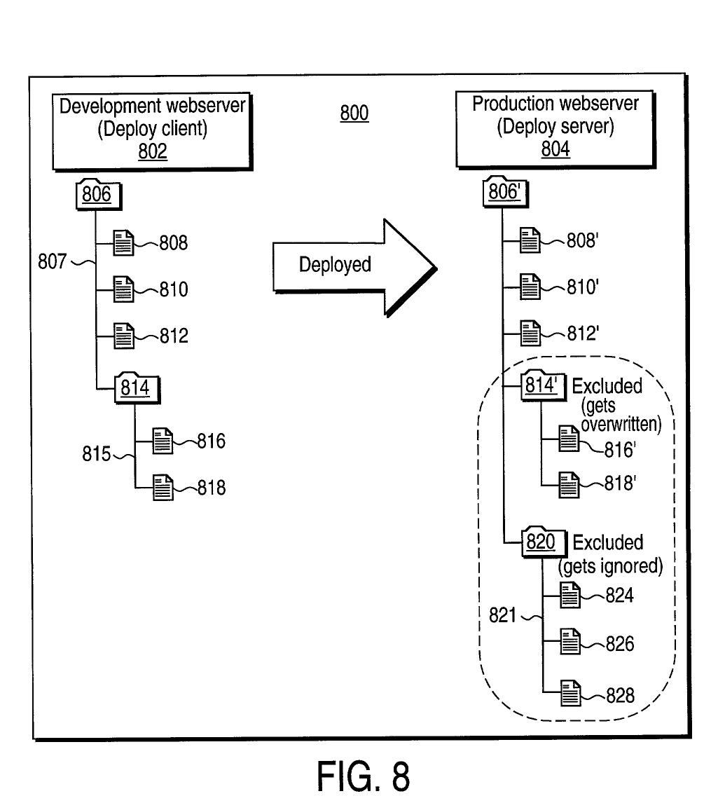

Referring to FIG. 8, and exemplary system 800 for excluding files from the destination side of the process, such as a production server, is illustrated. This is a scenario where files or directories are not excluded from a development server 802, but only excluded only from a production server 804 side. When a corresponding file or directory is deployed from the source, such as the development server 802, the existing file or directory on the destination side will be overwritten. If, however, there is no corresponding file or directory to some or all of those deployed, those files are ignored on the production server side. In the example, directory 806 includes branch 807 associating files 808, 810, 812 with the file. Similarly, sub-directory 814, also associated with the directory via the same branch, includes branch 815 associating files 816, 818 with this sub-directory. Upon deployment, all of these files and associated directories are deployed with out exclusion. Upon arrival at the production server 804, however, they are treated differently than the scenario discussed above and illustrated in FIG. 7. Corresponding directory 806′ along with associated files 808′, 810′, 812′ are deployed in normal course. The production server, such as illustrated, may include corresponding directory 814′ and associated corresponding files 816′, 818′. This directory along with its associated files, excluded on the production server 804, would be overwritten upon deployment. The production server 804 may also include one or more directories and files such as subdirectory 820, having branch 821 that associates files 824, 826, 828 with this subdirectory. Since these files have no corresponding files that were deployed, this directory and all of its associated files get ignored. Among many other advantages, this configuration allows a development server 802 to deploy certain directories and files, and leave certain other files located on the production server alone.

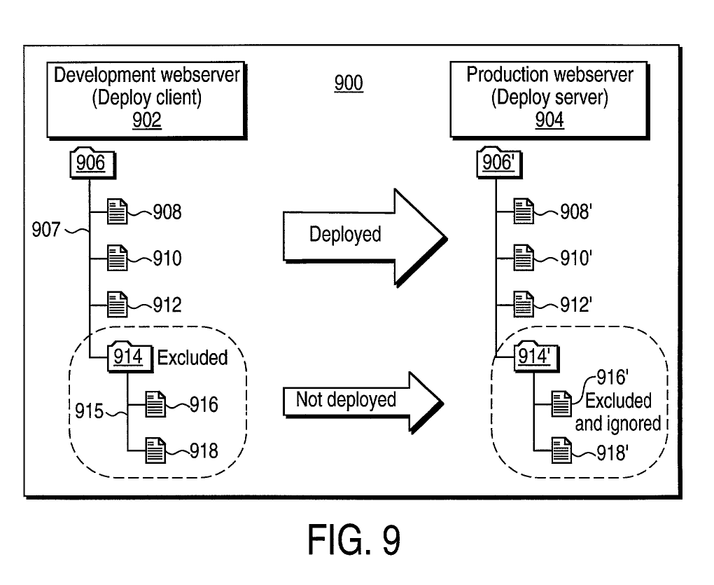

Referring to FIG. 9, a third configuration 900 for the system is illustrated, where files and directories may be excluded on both ends of the deployment. Development websever 902 is configured to deploy files and directories to production server 904 and includes directory 906 having a branch 907 that associates files 908, 910, 912 and subdirectory 914 with the directory. Corresponding directory 906′ along with corresponding associated files 908′, 910′, 912′ may be deployed as a matter of course. However, corresponding subdirectory 914′ along with corresponding associated files 916′, 918′, which are all excluded on both the deployment source and destination, are all excluded and ignored upon receiving the deployment at the production server 904. This allows all associated files that are excluded to be simply left alone on both sides of the transmission.

According to the invention, targets to which data is to be deployed can be specified, for example, specific production servers. Throughout a web development and maintenance system, deployments can take on many forms. Deployments can even occur in reverse, where a production server deploys its current content, for example, back to a development server. This may be useful in a scenario where it is desired that the development server track or otherwise monitor the activities of the production server. The tracking function discussed above and illustrated in FIG. 6 would be relevant for such a configuration.

The target of a deployment typically needs to be identified. For example, a deployment to a production server, such as a server that hosts a website, would typically require a port number and a server name. This information would allow the deploying entity to specify the path and the destination, basic criteria typically required to transfer data within a computer network. According to the invention, data may be deployed to multiple targets from a single location. Once data is authorized to be published, the data may be deployed to, for example, a number of production servers, for hosting of a website. This is a valuable feature that may be useful to websites that publish certain amount common information in different geographical regions, but that include other information in each individual region that may be specific to that region. Being able to deploy the data to remote locations from a single location according to the invention would be very useful to such an application, giving it the ability to geographically centralize the control of the website's maintenance and development.

In one embodiment of the invention, an application is configured to access a database without the need to search through all of the website hierarchical files looking for attributes. This is accomplished by selecting attributes (e.g., extended attributes) to represent website information relevant to searching. The attributes may be converted to data, such as tuples, suitable for storing in a database. The database may be more easily and conveniently searched than the file system. In tracking changes to a website made by a user at a work area, certain selected attributes are separately distinguished for easy searching. This provides an elegant compromise between a file system and a database. Organizations may wish to use file systems so that files can be maintained, the architecture can remain open and the files can be easy to work with. Attributes of files from the file system may be inserted into database so that data can be easily searched. The invention provides a useful hybrid architecture that allows for files to be maintained and also be easily identified and searched using separate extended attributed information that can be easily accessed by searching software. Organizing and tracking the transfer of these files is made more efficient by the invention, which organizes and tracks modifications to a website made at a workstation. This allows for the organization and tracking of changes made to a website by concurrent users. These extended attributes may be represented as a tuple and transferred among the system entities while the website is being developed.

In another embodiment of the invention, a method and apparatus for creating templates and dynamically using templates in deploying data is provided. The method of using templates provides a highly configurable way to capture, edit and store data imported from end-users who are developing websites. The method also provides for the integration of captured data with other applications, and allows a system to centralize administration of a website and its page design. In other words, one example of the utility of this feature of the invention is the ability for a system to enforce consistent processes for developing and maintaining a website among multiple workstations. Templates may be useful for deploying data internally, such as in a backing store, e.g., backing store 110 (FIG. 1), where data is stored for access by the various areas. Templates may also be useful externally among data destinations such as production servers for further consistency in website development and maintenance. The invention accomplishes this with the templates by efficiently keeping the data separate from the data template presentation. This allows the data to be transferred separately from the presentation so that the data can be modified. This also allows the ability to allow different templates to present the data. Furthermore, the invention provides for the extension of application tags so that a user of the system can add tags to the website easily. For example, a user may want to add a link to a database so that the database can be searched.

According to the invention, the template mechanism for capturing data content from end-users may be separate from the mechanism for defining the appearance of the contents when it is displayed. This architecture allows for the unlimited re-use of data after the data is captured and stored. It further allows a user to define different appearances and behaviors for the same data content based on how, when, where, or to whom the data is displayed. Once the data is captured, it is configured and stored according to a data capture template, which defines the data captured for use in a work area. The data stored in the data capture template can be displayed via presentation templates. Either template may optionally deployed to a database for storage. The isolation of the data apart from the manner in which it is presented allows for easy deployment and manipulation of the data. This feature also allows for the flexibility to deploy captured data according to different presentation templates. Moreover, if a default template is chosen and enforced, a system could allow a user to input data without having any website content development skill. A user may simply input or modify data, then deploy the resulting content, either internally or externally. No special programming skills are necessarily required.

In a preferred embodiment, templates are stored in Extensible Markup Language (XML). XML is an open standard that gives flexibility in incorporating textual and graphical data. The use of the standard allows a programmer to write definition that allows a system to capture data and store it in an XML data content record file. This data content is kept separate from whatever presentation template that is to be used to display the data. An XML template file is kept separate, and defines the manner in which the data content is presented on a web page. A work area may contain a directory of multiple presentation and data capture templates to be used in different applications. These different templates may be designed in a work area, or may be standardized within a system by a system administrator. The content created in a work area may then be merged with the template to produce an HTML file. Such methods of merging documents are well known to those skilled in the software programming arts. The file may then be deployed internally and stored in a database or other storage means.

The HTML file may also be used to display the content on a website according to the template. To display the new content on a production server, the HTML file may be deployed according to the methods discussed above in order to update a website on the production server. Since the data is kept in a separate file from the template file, either the data or the associated template may be modified, recombined, and then deployed with ease. Different templates may also be used to deploy the data according to the same or a different presentation at different locations.

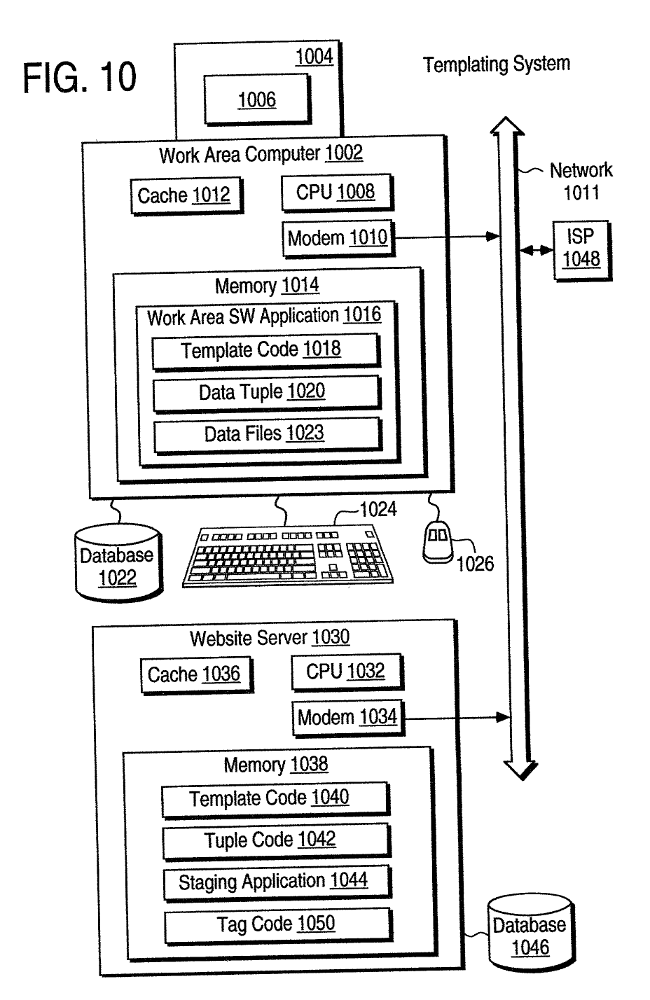

Referring to FIG. 10, a block diagram of a system employing a template application in accordance with the invention is illustrated. The system includes a work area computer 1002 connected to a monitor 1004 having a display 1006 for displaying data to a user. The work area computer 1002 includes a CPU 1008 for controlling the inter-workings of the computer and a modem 1010 connected to a network 1011 for sending information to other destinations. The work area computer 1002 further includes cache 1012 for storing frequently used data. Memory 1014, controlled by CPU 1008, can be a conventional memory and can be a random access memory (RAM), a dynamic random access memory (DRAM), a static random access memory (SRAM), or any other memory configured to store and transfer digital data therefrom. Thus, it will be apparent that the computer 1002 is conventional and that various modifications may be made to it. Memory 1014 includes work area software application 1016 that includes template codes for creating and storing templates used for displaying data. These templates define the displays used on the website, so that a user having a graphic user interface (GUI) can read the data displayed in the selected template format. Also stored in the memory 1014 is data tuple code 1020 for storing and transferring data in the tuple format. Also communicating with work area computer 1002 is an optional database 1022 for storing data that is easily accessed by a user. Data can optionally be stored in data files 1023, which gives a user an organized way to store data. Work area computer 1002 also includes a keyboard 1024 and mouse 1026 that allow a user to input data.

The website building system of FIG. 10 further includes a website server 1030 having a CPU 1032 for controlling the inter-workings of the server 1030 and a modem 1034 connected to network 1012 for transferring data using the network 1012. The server 1030 further includes a cache memory 1036 for storing frequently used data and a conventional memory 1038. Thus, it will be apparent that the server 1030 is a conventional server and that various modifications may be made to it. Memory 1038 may include template code 1040 for storing and creating templates to be used on a website. The server 1030 may further include tuple code 1042 for storing and transferring data in a tuple format. Tuple code may be a software application configured to deploy data. Further included is a staging application 1044 for staging contributions to the website by multiple work areas. The staging application 1044 can configure the template code and tuple code for displaying data on a website in a given template format. Also included is an optional database 1046 for storing data to be accessed by the website server 1032. ISP 1048 may also be included in the system of FIG. 10 to allow the work area computer 1002 and website server 1030 to exchange data via the Internet, another example of network 1011.

In general, the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, such implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively.

TABLE 1

| Development webserver | | Production webserver | | |
|---|---|---|---|---|
| (Deploy client) | | (Deploy server) | | Action |
| [symbol] | file 1 9/21/98 3:42 PM 23K | [symbol] | file 1 9/24/98 3:16 PM 23K | not deployed (development is older) |
| [symbol] | file 2 9/23/98 4:27 PM 98K | [symbol] | file 2 9/23/98 4:27 PM 98K | not deployed (same date, same size) |
| [symbol] | file 3 9/28/98 9:11 AM 35K | [symbol] | file 3 7/18/98 4:32 PM 37K | deployed (development is newer) |
| [symbol] | file 4 9/30/98 1:56 PM 56K | [symbol] | file 4 9/30/98 1:56 PM 32K | deployed (same date, different size) |
| [symbol] | file 5 9/27/98 4:38 PM 56K | | file 5 N/A | deployed (Production file does not exist) |
| | file 6 N/A | [symbol] | file 6 9/30/98 2:20 PM 56K | file does not exist on development |
| | | | | webserver; if do_deletes is specified, |
| | | | | the production file will be deleted. |
| | | | | Otherwise, the production file will be |
| | | | | ignored. |

TABLE 2

| Development webserver | | Production webserver | | |
|---|---|---|---|---|
| (Deploy client) | | (Deploy server) | | Action |
| [symbol] | file 1 9/21/98 3:42 PM 23K | [symbol] | file 1 9/24/98 3:16 PM 23K | deployed (development is older) |
| [symbol] | file 2 9/23/98 4:27 PM 98K | [symbol] | file 2 9/23/98 4:27 PM 98K | not deployed (same date, same size) |
| [symbol] | file 3 9/28/98 9:11 AM 35K | [symbol] | file 3 7/18/98 4:32 PM 37K | not deployed (development is newer) |
| [symbol] | file 4 9/30/98 1:56 PM 56K | [symbol] | file 4 9/30/98 1:56 PM 32K | deployed (same date, different size) |
| [symbol] | file 5 9/27/98 4:38 PM 56K | | file 5 N/A | deployed (Production file does not exist) |
| | file 6 N/A | [symbol] | file 6 9/30/98 2:20 PM 56K | file does not exist on development |
| | | | | webserver; if do_deletes is specified, |
| | | | | the production file will be deleted. |
| | | | | Otherwise, the production file will be |
| | | | | ignored. |

TABLE 3

| Development webserver | | Production webserver | | |
|---|---|---|---|---|
| (Deploy client) | | (Deploy server) | | Action |
| [symbol] | file 1 9/21/98 3:42 PM 23K | [symbol] | file 1 9/24/98 3:16 PM 23K | deployed (production date is different) |
| [symbol] | file 2 9/23/98 4:27 PM 98K | [symbol] | file 2 9/23/98 4:27 PM 98K | not deployed (same date, same size) |
| [symbol] | file 3 9/28/98 9:11 AM 35K | [symbol] | file 3 7/18/98 4:32 PM 37K | deployed (production date is different) |
| [symbol] | file 4 9/30/98 1:56 PM 56K | [symbol] | file 4 9/30/98 1:56 PM 32K | deployed (same date, different size) |
| [symbol] | file 5 9/27/98 4:38 PM 56K | | file 5 N/A | deployed (Production file does not exist) |
| | file 6 N/A | [symbol] | file 6 9/30/98 2:20 PM 56K | file does not exist on development |
| | | | | webserver; if do_deletes is specified, |
| | | | | the production file will be deleted. |
| | | | | Otherwise, the production file will be |
| | | | | ignored. |

1. A method of deploying data for use in website development and management comprising:
storing an original file defining baseline website content into a base table that is associated with one or more work areas;
copying the original data file to a work file work area;
modifying the work file;
recording the modifications made to the work file in a delta table;
submitting the modifications from the delta table to the base table for approval; and
if the modifications are approved, modifying the modifications in the associated base table.

2. A method of deploying data according to claim 1, wherein submitting the modifications from the delta table comprises:
organizing data into a tuple format;
transferring a tuple to a destination in the website management system;
storing the tuple in a memory location at the destination; and
tracking the transfer of the tuple in a tracking table.

3. A method of deploying data according to claim 1, wherein storing the original file further includes storing content data into an XML file and storing template data according a template that defines the manner in which the content data is to presented on a website.

4. A method of deploying data from a development server to a production server comprising:
designating a status for a file to be deployed;
associating content transfer information with the deploying the file to a production server;
concatenating the file with a corresponding file stored on the production server; and
producing the new content on the production server.
